(19) United States
(12) Patent Application Publication
(10) Pub. No.: US 2026/0121720 A1
(43) Pub. Date: Apr. 30, 2026

(54) METHODS AND SYSTEMS FOR REPORTING TIME DOMAIN CHANNEL PROPERTIES (TDCP)

(71) Applicant: Apple Inc., Cupertino, CA (US)

(72) Inventors: Haitong Sun, Cupertino, CA (US); Dawei Zhang, Saratoga, CA (US); Wei Zeng, Saratoga, CA (US); Ismael Gutierrez Gonzalez, San Jose, CA (US); Louay Jalloul, Cupertino, CA (US); David Neumann, Munich, Bavaria-Bayern (DE); Ghaith N. Hattab, Santa Clara, CA (US); Hong He, San Jose, CA (US)

(21) Appl. No.: 19/118,650

(22) PCT Filed: Oct. 26, 2023
(86) PCT No.: PCT/US2023/036056

§ 371 Date: Apr. 4, 2025

Related U.S. Application Data
(60) Provisional application No. 63/420,008, filed on Oct. 27, 2022.

(51) Int. Cl. H04B 7/06; H04L 27/26; H04W 72/0446

(52) U.S. Cl. CPC H04B 7/0626; H04L 27/26025; H04W 72/0446

(57) ABSTRACT

A user equipment (UE) includes a transceiver and a processor, which is configured to receive, from a radio access network (RAN) and via the transceiver, a configuration to transmit time domain channel properties (TDCP) based on measurement of a tracking reference signal (TRS) received at the UE, and measure the TRS. The processor is configured to transmit, to the RAN and via the transceiver, at least one of a processing time or a number of channel state information (CSI) processing units (CPUs) required to report the TDCP based on the measurement of the TRS. The processor is configured to transmit, to the RAN and via the transceiver, a CSI report including the TDCP, the TDCP based on the measurement of the TRS.

### CROSS-REFERENCE TO RELATED APPLICATION

This Patent Cooperation Treaty patent application claims priority to U.S. Provisional Patent Application No. 63/420,008, filed Oct. 27, 2022, and titled “Methods and Systems for Reporting Time Domain Channel Properties (TDCP),” the contents of which are incorporated herein by reference in its entirety.

### TECHNICAL FIELD

This application relates generally to wireless communication systems, including methods and systems for measuring and reporting time domain channel properties (TDCP) for 5G New Radio (5G NR).

### BACKGROUND

Wireless mobile communication technology uses various standards and protocols to transmit data between a network device of a radio access network (RAN), for example, a base station, and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, a base station, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device (e.g., a base station) used by a RAN may correspond to that RAN. One example of an E-UTRAN network device is an Evolved Universal Terrestrial Radio Access Network (E-UTRAN) Node B (also commonly denoted as evolved Node B, enhanced Node B, eNodeB, or eNB). One example of an NG-RAN network device is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 shows an example diagram of a minimum processing time required by a user equipment (UE) in time unis for TDCP reporting based on a tracking reference signal (TRS), in accordance with some embodiments.

FIG. 3 shows an example diagram of a minimum processing time required by a user equipment (UE) in symbol unis for TDCP reporting based on a tracking reference signal (TRS), in accordance with some embodiments.

FIG. 4 shows an example of an active channel state information reference signal (CSI-RS) rule for various types of CSI-RS activated using different methods, in accordance with some embodiments.

FIG. 5 shows an example method of operations being performed by a UE for reporting TDCP for 5G NR, in accordance with some embodiments.

FIG. 6 shows an example method of operations being performed by a network device of a RAN (e.g., a base station) for receiving TDCP for 5G NR from a UE, in accordance with some embodiments.

FIG. 7 illustrates an example architecture of a wireless communication system, according to embodiments disclosed herein.

FIG. 8 illustrates a system for performing signaling between a wireless device and a network device, according to embodiments disclosed herein.

### DETAILED DESCRIPTION

Various embodiments related to measuring and reporting of time domain channel properties (TDCP) using a channel state information reference signal (CSI-RS) for tracking are described. The CSI-RS for tracking may be referenced in the present disclosure as a tracking reference signal (TRS). Third Generation Partnership Project (3GPP) Releases 15, 16, and 17 describe advanced channel state information (CSI) reporting for exploiting channel correlations. Channel correlations described in 3GPP Releases 15, 16, and 17 may correspond with channel spatial correlation for high resolution CSI feedback for a Type 1 and Type 2 multi-input multi-output (MIMO) codebook, or channel frequency correlation that reduces CSI overhead in a Type II CSI Release 16 enhancement. Channel correlations described in 3GPP Releases 15, 16, and 17 may correspond with a channel downlink (DL) and uplink (UL) correlation for exploiting reciprocity based MIMO; for example, supporting a non-codebook based physical uplink shared channel (PUSCH) operation, and supporting reporting of a CSI-RS resource indicator (CRI), a rank indicator (RI), and a channel quality indicator (CQI) for a DL operation, and a Type II port selection codebook for a DL operation. However, channel correlation in time domain is not exploited, in particular, for 5G (or 5G NR). Accordingly, various embodiments described herein support measuring and reporting of TDCP since wireless channel properties vary over time due to movement of the UE and a speed of movement of the UE, and/or with a change in a UE environment. In some embodiments, the TDCP may be useful for MIMO enhancements. The TDCP properties are measured using TRS, which is currently not supported in 5G (or 5G NR). Accordingly, various embodiments described herein enable reporting of TDCP using TRS in 5G NR, and provide details of a UE processing time requirement, and a number of CSI processing units (CPUs) required to report the TDCP based on measurement of the TRS according to an active CSI-RS rule. In some embodiments, and by way of a non-limiting example, another appropriate reference signal in place of TRS may be used to report TDCP.

Reference will now be made in detail to representative embodiments/aspects illustrated in the accompanying drawings. The following description is not intended to limit the embodiments to one preferred embodiment. On the contrary, it is intended to cover alternatives, combinations, modifications, and equivalents as can be included within the spirit and scope of the described embodiments as defined by the appended claims.

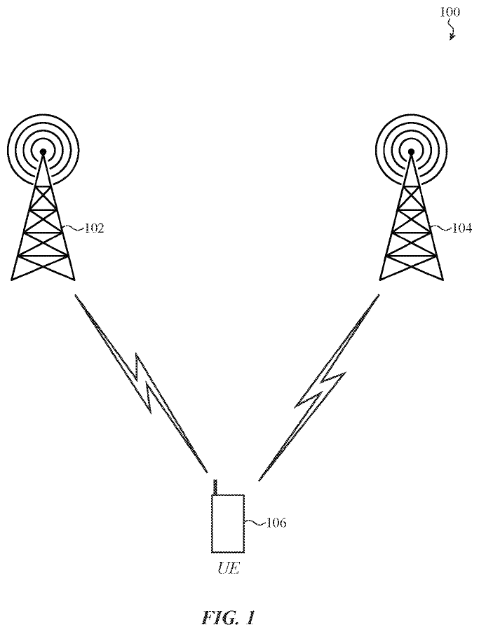

FIG. 1 shows an example wireless communication system, according to embodiments described herein. As shown in FIG. 1, a wireless communication system 100 may include a network device 102, a network device 104, and a user equipment (UE) 106. The UE 106 may be communicatively coupled with the network device 102 and/or the network device 104, to transmit data in an uplink (UL) direction and/or to receive data in a downlink (DL) direction. In some embodiments, the network devices 102, and 104 may be an eNb, an eNodeB, a gNodeB, or an access point (AP) in a radio access network (RAN) and may support one or more radio access technologies, such as 4G, 5G, 5G new radio (5G NR), 6G, and so on. The UE 106 may be a phone, a smart phone, a tablet, a smartwatch, an Internet-of-Things (IoT), a vehicle, and so on.

A CSI report describes a state of a channel. A UE may transmit a CSI report to a network device as feedback. The CSI report may include several parameters, such as a channel quality indicator (CQI), a precoding matrix indicator (PMI) with different codebook sets, and a rank indicator (RI). The CSI report may also include information regarding channel correlation supported by Releases 15, 16, and 17, and also TDCP as described herein in accordance with some embodiments. The UE may use a channel state information reference signal (CSI-RS) to measure CSI feedback, and in particular a TRS to measure TDCP, and generate a CSI report. Upon receiving the CSI report, the network device may schedule data transmission in a DL direction and/or an UL direction.

The CSI report may be a periodic CSI (P-CSI) report, an aperiodic CSI (AP-CSI) report, and/or a semi-persistent CSI (SP-CSI) report. A UE processing time (or a minimum UE processing time) for the CSI report may depend on the type of the CSI report. For example, for a P-CSI report or an SP-CSI report, the CSI processing time required by the UE may be 4 or 5 milliseconds (ms). A minimum processing time required by a UE is described using FIG. 2. The CSI report may be used to report TDCP to a network device, which may be a network device of a RAN (e.g., a base station).

FIG. 2 shows an example diagram of a minimum processing time required by a user equipment (UE) in time units for TDCP reporting based on a tracking reference signal (TRS), in accordance with some embodiments. As shown in a diagram 200 in FIG. 2, reference signals (e.g., CSI-RSs) RS1 204 and RS2 206 are shown along a time axis 202. A minimum processing time required by the UE for measuring TDCP 210 may be a time between the last reference signal, such as RS2 206 and transmitting a CSI report 208 in a PUSCH.

Alternatively, or additionally, the minimum processing time required by the UE may be represented in symbol units or as a number of symbols. If a single CSI-RS or a synchronization signal block (SSB) is configured for channel measurement, n_{CSI_ref} is the smallest value greater than or equal to 4*2^{μ}_{DL} such that it corresponds to a valid downlink slot, and if multiple CSI-RSs or SSBs are configured for channel measurement, n_{CSI_ref} is the smallest value greater than or equal to 5*2^{μ}_{DL} such that it corresponds to a valid downlink slot.

For an AP-CSI report, the CSI processing time, as a number of symbols, may be defined using Z and Z′, where Z correspond-, with a time between an end of an AP-CSI triggering physical download control channel (PDCCH) transmission, such as downlink control information (DCI), and beginning of a PUSCH carrying an AP-CSI report, and Z′ corresponds with a time between an end of the last measurement resource (e.g., a CSI-RS) and a beginning of a PUSCH carrying an AP-CSI report. For example, for a subcarrier spacing (SCS) shown here as μ, values of Z and Z′ for low latency CSI computation may be as shown in Table 1, and for regular CSI computation may be as shown in Table 2.

TABLE 1

Z₁ [Symbols]

| μ | Z₁ | Z₁′ |
|---|---|---|
| 0 | 10 | 8 |
| 1 | 13 | 11 |
| 2 | 25 | 21 |
| 3 | 43 | 36 |

TABLE 2

| | Z₁ [Symbols] | | Z₂ [Symbols] | | Z₃ [Symbols] | |
|---|---|---|---|---|---|---|
| μ | Z₁ | Z₁′ | Z₂ | Z₂′ | Z₃ | Z₃′ |
| 0 | 22 | 16 | 40 | 37 | 22 | X₀ |
| 1 | 33 | 30 | 72 | 69 | 33 | X₁ |
| 2 | 44 | 42 | 141 | 140 | min(44, X₂ + KB₁) | X₂ |
| 3 | 97 | 85 | 152 | 140 | min(97, X₃ + KB₂) | X3 |
| 5 | 388 | 340 | 608 | 560 | min(388, X₅ + KB₃) | X₅ |
| 6 | 776 | 680 | 1216 | 1120 | min(776, X₆ + KB₄) | X₆ |

In Table 2 above, (Z₁, Z₁′) may correspond with a low complexity link adaptation CSI (LA-CSI) or a layer 1 signal-to-interference plus noise ratio (L1-SINR) measurement, (Z₂, Z₂′) may correspond with a high complexity link adaptation CSI (LA-CSI), and (Z₃, Z₃′) may correspond with a layer 1 reference signal received power (L1-RSRP) measurement (e.g., beam management CSI (BM-CSI)).

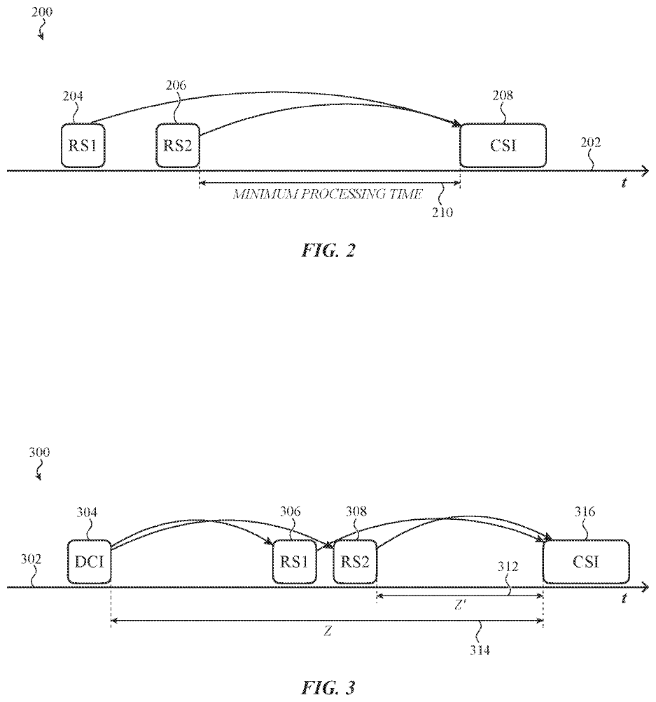

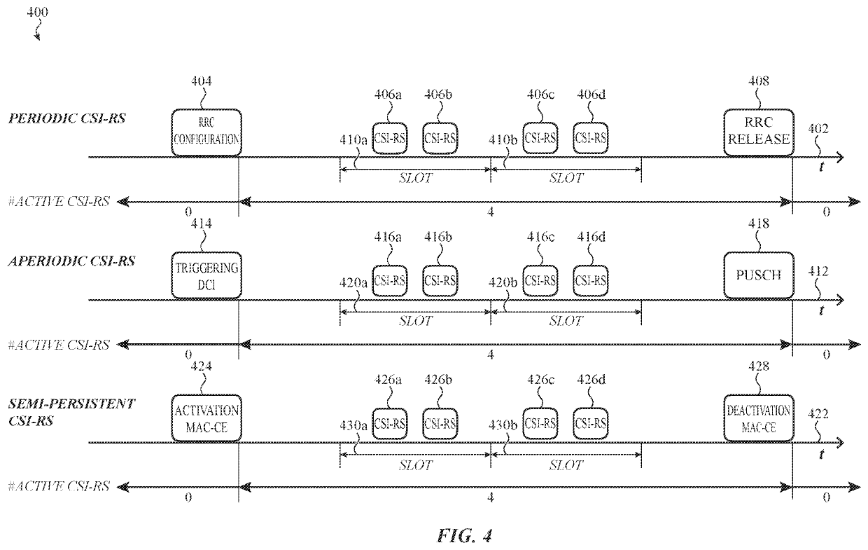

FIG. 3 shows an example diagram of a minimum processing time required by a user equipment (UE) in symbol units for TDCP reporting based on a tracking reference signal (TRS), in accordance with some embodiments. As shown in a diagram 300, reference signals (e.g., CSI-RSs) RS1 306 and RS2 308 are shown along a time axis 302. As described above, Z 314 corresponds with a time between an end of a physical download control channel (PDCCH) transmission, such as a downlink control information (DCI) 304 triggering a CSI, and the beginning of a PUSCH carrying a CSI report 316, and Z′ 312 corresponds with a time between an end of the last measurement resource (e.g., the RS2 308) and the beginning of the PUSCH carrying the CSI report 316.

In some embodiments, a UE may be configured to report TDCP based on a measurement performed on a TRS in a P-CSI report or an SP-CSI report, and a processing time (or a minimum processing time) required by the UE may be in time units, for example, 4 ms or 5 ms. The processing time (or the minimum processing time) required by the UE may be reported by the UE as a UE capability or specified as a fixed value in the specification (or in other words, a predetermined fixed value). The processing time (or the minimum processing time) required by the UE may depend on a subcarrier spacing (SCS), and only one value of the processing time (or the minimum processing time) required by the UE may be reported as the UE capability regardless of the SCS. In some embodiments, the processing time (or the minimum processing time) required by the UE for each SCS may be reported as the UE capability. The SCS may be a SCS for a DL channel or DL signal, a SCS for a UL channel, or a minimum of a SCS for a DL channel and/or signal and a SCS for a UL channel and/or signal. The UE capability may be reported in a UE capability information element via radio resource control (RRC) signaling or as a MAC control element (MAC CE).

In some embodiments, a UE may be configured to report TDCP based on a measurement on a TRS using an AP-CSI report, and a processing time (or a minimum processing time) may be according to Table 1 shown herein for a low latency CSI report. If a UE supports a low latency CSI report, the UE may report to a network device, for example, as a UE capability, if the UE supports a low latency CSI report of TDCP. The low latency CSI report of TDCP may be triggered by a network device (or a network) in various conditions including, but not limited to, where a SCS corresponding to a CSI report is not greater than, for example, 120 kHz, or a PUSCH carrying a CSI report (or an AP-CSI report) is not scheduled to carry an UL shared control channel (UL-SCH) or hybrid automatic repeat request acknowledgement (HARQ-ACK). The various conditions triggering the low latency CSI report of TDCP may also include where a UE is not expected to multiplex an uplink control information (UCI) on a PUSCH carrying an AP-CSI report, or a CPU other than the CPU required to report the TDCP based on measurement of the TRS is not simultaneously occupied.

In some embodiments, a UE may not support a low latency CSI report (or supports a regular or normal latency CSI report), and a processing time (or a minimum processing time) may be according to Table 2 shown herein. The processing time (or the minimum processing time) in symbol units (or as a number of symbols) may be selected from a pair of Z₁ and Z₁′ symbols. For a frequency range-2 (FR2), the processing time (or the minimum processing time) in symbol units (or as a number of symbols) may be selected from a pair of Z₃ and Z₃′ symbols. As shown in Table 2, the processing time (or the minimum processing time) in symbol units (or as a number of symbols) varies with the SCS. The SCS may be a minimum of a SCS of a scheduling physical downlink control channel (PDCCH), a SCS of a PUSCH carrying an AP-CSI report, and a SCS of reference signals used for AP-CSI measurement. The AP-CSI report may be used to report TDCP to a network device (or a network).

In some embodiments, a UE may be configured to report TDCP, based on a measurement performed on a TRS, using a CSI report (e.g., a P-CSI report or an SP-CSI report), and the TRS may be a periodic tracking reference signal (P-TRS) that is configured as a set of Non-Zero-Power (NZP) CSI-RS resources (NZP-CSI-RS-ResourceSet). The NZP-CSI-RS-ResourceSet may have a trs-info field set to true. The trs-info field set to true may indicate that an antenna port for all NZP-CSI-RS resources in the CSI-RS resource set is the same. If the trs-info field is absent, a UE may consider that the trs-info field is set to false.

In some embodiments, and by way of a non-limiting example, a NZP-CSI-RS-ResourceSet for a P-TRS may be configured with two NZP-CSI-RS-Resources in one slot, or four NZP-CSI-RS-Resources in two adjacent slots (each slot including two NZP-CSI-RS-Resources). In some embodiments, a number of occupied CPU(s) may correspond with a number of configured NZP-CSI-RS-Resources, or a number of slots. When the number of occupied CPU(s) corresponds with the number of slots, the number of occupied CPU(s) may correspond with a number of slots for TRS. In other words, a 1-slot TRS may have a number of occupied CPU(s) as 1, a 2-slot TRS may have a number of occupied CPUs as 2. In some embodiments, a number of occupied CPU(s) may be a fixed value, such as 0, 1, 2, 3, and/or 4. A UE may be configured to report a number of occupied CPU(s). The UE may report a different number of CPU(s) for a 1-slot TRS and a 2-slot TRS.

In some embodiments, a UE may be configured to report TDCP, based on a measurement performed on a TRS, using a CSI report (e.g., an AP-CSI report), and the TRS may be configured as an aperiodic TRS configured to perform measurement by a UE. The aperiodic TRS may be configured as an aperiodic set of Non-Zero-Power (NZP) CSI-RS resources (NZP-CSI-RS-ResourceSet). The NZP-CSI-RS-ResourceSet may have a trs-info field set to true. In some embodiments, and by way of a non-limiting example, the aperiodic NZP-CSI-RS-ResourceSet may include two NZP-CSI-RS-Resources in one slot. In some embodiments, and by way of a non-limiting example, an aperiodic TRS may be quasi collocated (QCL'd) or associated with a P-TRS, as described herein. A number of occupied CPU(s) for the AP-CSI report may correspond with a number of configured NZP-CSI-RS-Resources (e.g., four), a number of configured NZP-CSI-RS-ResourceSets (e.g., two), or according to a number of occupied CPUs reported by a UE. If a network triggers a low latency CSI report, then all the CPUs may be occupied.

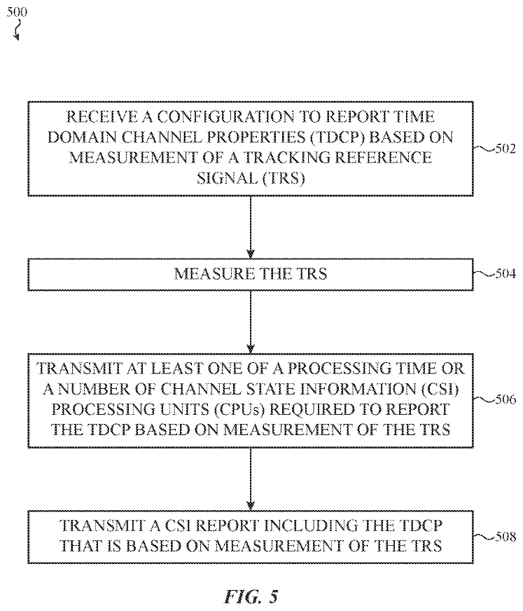

FIG. 4 shows an example of an active channel state information reference signal (CSI-RS) rule for various types of CSI-RS activated using different methods, in accordance with some embodiments. As shown in a diagram 400, a CSI report for reporting TDCP to a network device (or a network) may be a CSI report that is based on a periodic CSI-RS such as 406a, 406b, 406c, and 406d shown along a time axis 402. As shown in FIG. 4, two CSI-RSs 406a and 406b may be during a slot 410a, and two CSI-RSs 406c and 406d may be during a slot 410b, as described above that there can be two CSI-RS resources (e.g., two NZP-CSI-RS-Resources) in one slot for measuring and reporting TDCP. Periodic CSI-RS may be configured and/or released using RRC signaling, and, accordingly, an active CSI-RS period may begin upon receiving a configuration corresponding to CSI-RS resources from a network device (or a network) using RRC signaling, shown as 404, and end when the configuration corresponding to the CSI-RS resources is released, shown as 408.

In some embodiments, as shown in a diagram 400, a CSI report for reporting TDCP to a network device (or a network) may be a CSI report that is based on an aperiodic CSI-RS such as 416a, 416b, 416c, and 416d shown along a time axis 412. As shown in FIG. 4, two CSI-RSs 416a and 416b may be during a slot 420a, and two CSI-RSs 416c and 416d may be during a slot 420b, which may be as described above that there can be two CSI-RS resources (e.g., two NZP-CSI-RS-Resources) in one slot for measuring and reporting TDCP. A CSI report based on an aperiodic CSI-RS may be configured using downlink control information (DCI), and, accordingly, an active CSI-RS period may begin upon an end of a PDCCH (e.g., DCI shown as 414), from a network device (or a network), including a request to measure and report TDCP, and end when a PUSCH carrying a CSI report for reporting TDCP is transmitted, shown as 418.

In some embodiments, as shown in a diagram 400, a CSI report for reporting TDCP to a network device (or a network) may be a CSI report that is based on a semi-persistent CSI-RS such as 426a, 426b, 426c, and 426d shown along a time axis 422. As shown in FIG. 4, two CSI-RSs 426a and 426b may be during a slot 430a, and two CSI-RSs 426c and 426d may be during a slot 430b, which may be as described above that there can be two CSI-RS resources (e.g., two NZP-CSI-RS-Resources) in one slot for measuring and reporting TDCP. Semi-persistent CSI-RS may be activated and/or deactivated using a MAC CE, and, accordingly, an active CSI-RS period may begin upon an end of when a MAC CE received from a network device (or a network) shown as 424 is applied, and end when a deactivation command using another MAC CE is received from a network device (or a network), shown as 428.

In some embodiments, and by way of a non-limiting example, a CSI-RS resource (e.g., a NZP-CSI-RS-Resource) configured for performing a measurement for TDCP may be according to an active CSI-RS rule in which an active CSI-RS rule period only corresponds to a slot in which a NZP-CSI-RS-Resource is transmitted, or in one or more slots in which a NZP-CSI-RS-ResourceSet including the corresponding a NZP-CSI-RS-Resource is configured.

FIG. 5 shows an example method of operations being performed by a UE for reporting TDCP for 5G NR, in accordance with some embodiments. As shown in a flow-chart 500, at 502, a UE may receive from a network device (or a network) a configuration to report TDCP based on measurement on TRS received at the UE. The configuration may be received using RRC signaling, a DCI, and/or a MAC CE, as described herein. The configuration may provide details or information of a type of CSI-RS for measurement of TDCP. The type of CSI-RS for measurement of TDCP may be a periodic CSI-RS, an aperiodic CSI-RS, or a semi-persistent CSI-RS. The configuration received at the UE may also suggest an active CSI-RS rule or period for measurement for TDCP.

At 504, the UE may perform a measurement on a TRS for reporting TDCP in a CSI report. At 506, a UE may transmit (e.g., report) to a network device (or a network) a processing time, which by way of a non-limiting example may be a minimum processing time, required by the UE for measurement of TDCP. The processing time (or the minimum processing time) may be reported as time units or as a number of symbols, as described herein. A UE may also or alternatively report, at 506, a number of CPUs required to report the TDCP based on a measurement performed on a TRS, as described herein, and accordingly these details are not being repeated for brevity. At 508, a UE may transmit to a network device (or a network) a CSI report including the TDCP based on a measurement performed on a TRS, shown here as 504. The TRS may be received from the network device according to the configuration received at 502.

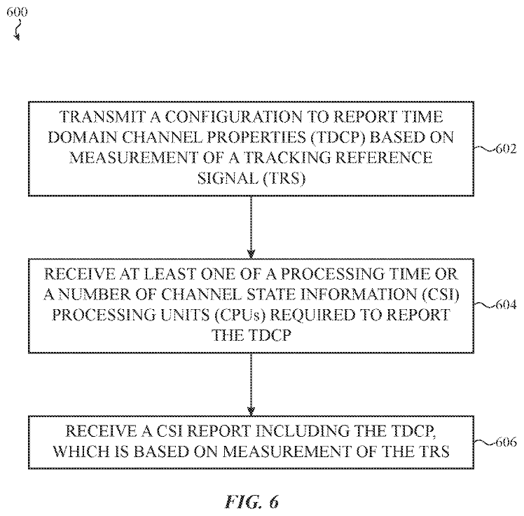

FIG. 6 shows an example method of operations being performed by a network device of a RAN (e.g., base station) for receiving TDCP for 5G NR from a UE, in accordance with some embodiments. As shown in a flow-chart 600, at 602, a network device may transmit to a UE a configuration to report TDCP based on measurement on TRS received at the UE. The configuration may be transmitted using RRC signaling, a DCI, and/or a MAC CE, as described herein. The configuration may provide details or information of a type of CSI-RS for measurement of TDCP. The type of CSI-RS for measurement of TDCP may be a periodic CSI-RS, an aperiodic CSI-RS, or a semi-persistent CSI-RS. The configuration received at the UE may also suggest an active CSI-RS rule or period for measurement for TDCP.

At 604, the network device may receive from a UE a minimum processing time required by the UE for measurement of TDCP. The minimum processing time may be reported as time units or as a number of symbols, as described herein. The minimum processing time may be reported to the network device as a UE capability. The network device may also receive, at 504, a number of CPUs required to report the TDCP based on a measurement performed on a TRS, as described herein, and accordingly these details are not being repeated for brevity. At 606, the network device may receive, from a network device (or a network), a CSI report including the TDCP based on a measurement performed on a TRS received at the UE according to the configuration transmitted to the UE at 602.

Embodiments contemplated herein include an apparatus having means to perform one or more elements of the method 500 or 600. In the context of method 500, the apparatus may be, for example, an apparatus of a UE (such as a wireless device 802 that is a UE, as described herein). In the context of method 600, the apparatus may be, for example, a network device 820, such as a base station, as described herein).

Embodiments contemplated herein include one or more non-transitory computer-readable media storing instructions to cause an electronic device, upon execution of the instructions by one or more processors of the electronic device, to perform one or more elements of the method 500 or 600. In the context of method 500, the non-transitory computer-readable media may be, for example, a memory of a UE (such as a memory 806 of a wireless device 802 that is a UE, as described herein). In the context of method 600, the non-transitory computer-readable media may be, for example, a memory of a network device (such as a memory 824 of a network device 820, as described herein).

Embodiments contemplated herein include an apparatus having logic, modules, or circuitry to perform one or more elements of the method 500 or 600. In the context of method 500, the apparatus may be, for example, an apparatus of a UE (such as a wireless device 802 that is a UE, as described herein). In the context of method 600, the apparatus may be, for example, a network device 820, such as a base station, as described herein).

Embodiments contemplated herein include an apparatus having one or more processors and one or more computer-readable media, using or storing instructions that, when executed by the one or more processors, cause the one or more processors to perform one or more elements of the method 500 or 600. In the context of method 500, the apparatus may be, for example, an apparatus of a UE (such as a wireless device 802 that is a UE, as described herein). In the context of the method 600, the apparatus may be, for example, a network device 820, such as a base station, as described herein).

Embodiments contemplated herein include a signal as described in or related to one or more elements of the method 500 or 600.

Embodiments contemplated herein include a computer program or computer program product having instructions, wherein execution of the program by a processor causes the processor to carry out one or more elements of the method 500 or 600. In the context of method 500, the processor may be a processor of a UE (such as a processor(s) 804 of a wireless device 802 that is a UE, as described herein), and the instructions may be, for example, located in the processor and/or on a memory of the UE (such as a memory 806 of a wireless device 802 that is a UE, as described herein). In the context of method 600, the processor may be a processor of a base station (such as a processor(s) 822 of a network device 820, as described herein), and the instructions may be, for example, located in the processor and/or on a memory of the network device (such as a memory 824 of a network device 820, as described herein).

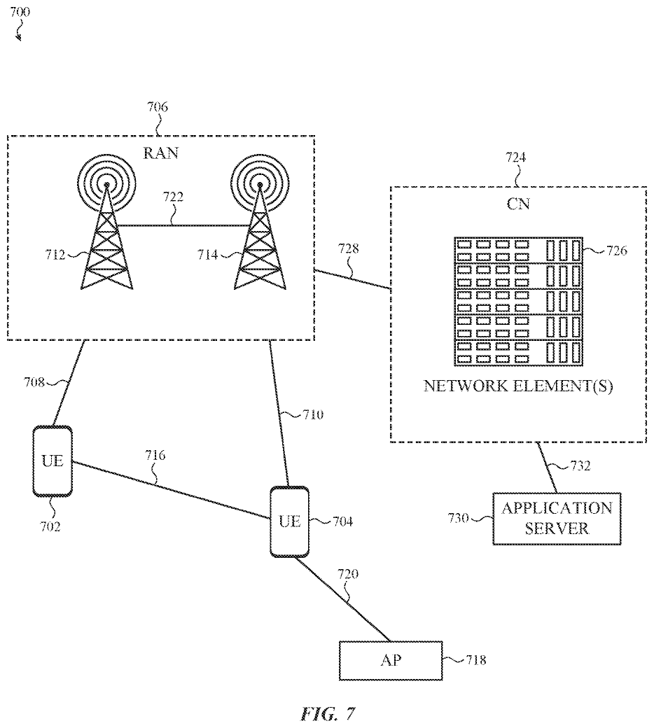

FIG. 7 illustrates an example architecture of a wireless communication system 700, according to embodiments disclosed herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more network devices (e.g., base stations), such as a network device 712 and a network device 714, that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the network device 712 and/or the network device 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the network device 712 or network device 714 may be implemented as one or more software entities running on server computers as part of a virtual network. In addition, or in other embodiments, the network device 712 or network device 714 may be configured to communicate with one another via interface 722. In embodiments where the wireless communication system 700 is an LTE system (e.g., when the CN 724 is an EPC), the interface 722 may be an X2 interface. The X2 interface may be defined between two or more network devices (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more network devices (e.g., two or more gNBs and the like) that connect to 5GC, between a network device 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the network device 712 or network device 714 and a serving gateway (S-GW), and the S1-MME interface, which is a signaling interface between the network device 712 or network device 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the network device 712 or network device 714 and a user plane function (UPF), and the S1 control plane (NG-C) interface, which is a signaling interface between the network device 712 or network device 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

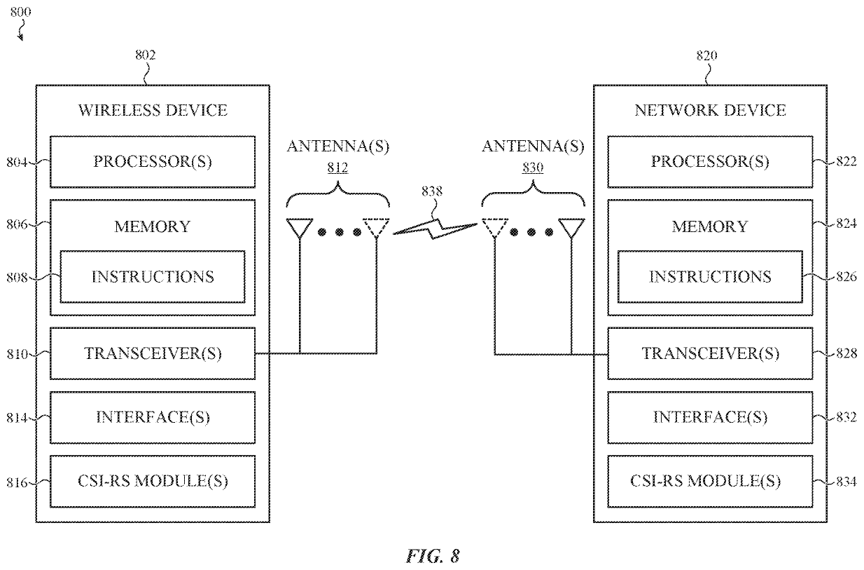

FIG. 8 illustrates a system 800 for performing signaling 838 between a wireless device 802 and a network device 820, according to embodiments disclosed herein. The system 800 may be a portion of a wireless communication system as herein described. The wireless device 802 may be, for example, a UE of a wireless communication system. The network device 820 may be, for example, a network device (e.g., a base station, an eNB, or a gNB) of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter and/or receiver circuitry that use the antenna(s) 812 of the wireless device 802 to facilitate signaling (e.g., the signaling 838) to and/or from the wireless device 802 with other devices (e.g., the network device 820) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multiuser MIMO (MU-MIMO) methods (where individual data streams may be directed to individual (different) receivers in different locations in the spatial domain).

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include one or more CSI measurement and reporting module(s) shown as CSI-RS module(s) 816 in FIG. 8. The CSI measurement and reporting module(s) 816 may be implemented via hardware, software, or combinations thereof. For example, the CSI measurement and reporting module(s) 816 may be implemented as a processor, circuit, and/or instructions 808 stored in the memory 806 and executed by the processor(s) 804. In some examples, the CSI measurement and reporting module(s) 816 may be integrated within the processor(s) 804 and/or the transceiver(s) 810. For example, the CSI measurement and reporting module(s) 816 may be implemented by a combination of software components (e.g., executed by a DSP or a general processor) and hardware components (e.g., logic gates and circuitry) within the processor(s) 804 or the transceiver(s) 810.

The CSI measurement and reporting module(s) 816 may be used for various aspects of the present disclosure, for example, aspects of FIGS. 1-6. The CSI measurement and reporting module(s) 816 may be configured to, for example, configure CSI measurement and reporting and transmit one or more CSI reports to another device (e.g., to the network device 820).

The network device 820 may include one or more processor(s) 822. The processor(s) 822 may execute instructions such that various operations of the network device 820 are performed, as described herein. The processor(s) 804 may include one or more baseband processors implemented using, for example, a CPU, a DSP, an ASIC, a controller, an FPGA device, another hardware device, a firmware device, or any combination thereof configured to perform the operations described herein.

The network device 820 may include a memory 824. The memory 824 may be a non-transitory computer-readable storage medium that stores instructions 826 (which may include, for example, the instructions being executed by the processor(s) 822). The instructions 826 may also be referred to as program code or a computer program. The memory 824 may also store data used by, and results computed by, the processor(s) 822.

The network device 820 may include one or more transceiver(s) 828 that may include RF transmitter and/or receiver circuitry that use the antenna(s) 830 of the network device 820 to facilitate signaling (e.g., the signaling 838) to and/or from the network device 820 with other devices (e.g., the wireless device 802) according to corresponding RATs.

The network device 820 may include one or more antenna(s) 830 (e.g., one, two, four, or more). In embodiments having multiple antenna(s) 830, the network device 820 may perform MIMO, digital beamforming, analog beamforming, beam steering, etc., as has been described.

The network device 820 may include one or more interface(s) 832. The interface(s) 832 may be used to provide input to or output from the network device 820. For example, a network device 820, which may be a network device (e.g., a base station), may include interface(s) 832 made up of transmitters, receivers, and other circuitry (e.g., other than the transceiver(s) 828/antenna(s) 830 already described) that enables the network device to communicate with other equipment in a core network, and/or that enables the network device to communicate with external networks, computers, databases, and the like for purposes of operations, administration, and maintenance of the network device or other equipment operably connected thereto.

The network device 820 may include one or more CSI report configuration module(s) shown as CSI-RS module(s) 834 in FIG. 8. The CSI report configuration module(s) 834 may be implemented via hardware, software, or combinations thereof. For example, the CSI report configuration module(s) 834 may be implemented as a processor, circuit, and/or instructions 826 stored in the memory 824 and executed by the processor(s) 822. In some examples, the CSI report configuration module(s) 834 may be integrated within the processor(s) 822 and/or the transceiver(s) 828. For example, the CSI report configuration module(s) 834 may be implemented by a combination of software components (e.g., executed by a DSP or a general processor) and hardware components (e.g., logic gates and circuitry) within the processor(s) 822 or the transceiver(s) 828.

The CSI report configuration module(s) 834 may be used for various aspects of the present disclosure, for example, aspects of FIGS. 1-6 from a perspective of a network device (e.g., the wireless device 820).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, a network device (e.g., a base station), a network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus comprising memory coupled to a processor, the processor configured to:
receive, from a radio access network (RAN), a configuration to report time domain channel properties (TDCP) based on measurement of a tracking reference signal (TRS) received at the UE;
measure the TRS;
transmit, to the RAN, a number of channel state information (CSI) processing units (CPUs) required to report the TDCP based on the measurement of the TRS; and
transmit, to the RAN, a CSI report including the TDCP, the TDCP based on the measurement of the TRS.

2. The apparatus of claim 1, wherein the CSI report is an aperiodic CSI report.

3. The apparatus of claim 1, wherein the CSI report that is not a low latency CSI report.

4. The apparatus of claim 1, wherein a processing time for an aperiodic CSI report including the TDCP is a substantially similar processing time as a periodic CSI report or a semi-persistent CSI report not including the TDCP.

5. The apparatus of claim 1, wherein the CSI report is a periodic CSI report.

6. The apparatus of claim 1, wherein the CSI report is a semi-persistent CSI report.

7. The apparatus of claim 1, wherein the number of CPUs required to report the TDCP is reported as a UE capability in a UE capability information.

8. The apparatus of claim 1, wherein a processing time required to report the TDCP corresponds with one or more sub-carrier spacing (SCS) values.

9. The apparatus of claim 8, wherein the processing time includes a first processing time to report the TDCP for a first sub-carrier spacing (SCS) and a second processing time to report the TDCP for a second sub-carrier spacing (SCS), the second processing time different from the first processing time.

10. The apparatus of claim 9, wherein the first SCS or the second SCS corresponds with a SCS of a downlink (DL) channel, a DL signal, or a minimum SCS of DL channels/signals and uplink (UL) channels.

11. The apparatus of claim 1, wherein the TRS is a periodic tracking reference signal (P-TRS) that is configured as a set of periodic Non-Zero-Power (NZP) CSI-RS resources (NZP-CSI-RS-ResourceSet).

12. The apparatus of claim 11, wherein the NZP-CSI-RS-ResourceSet has trs-info set to true.

13. The apparatus of claim 1, wherein the measurement on the TRS is performed in accordance with an active channel state information reference signal (CSI-RS) rule, the active CSI-RS rule corresponds with an active CSI-RS in a slot in which a Non-Zero-Power (NZP) CSI-RS resource (NZP-CSI-RS-Resource) is transmitted or a slot in which a set of Non-Zero-Power (NZP) CSI-RS resources (NZP-CSI-RS-ResourceSet) including a NZP-CSI-RS-Resource is configured.

14. The apparatus of claim 13, wherein:
the active CSI-RS starts in accordance with a periodic CSI-RS configuration configured using radio resource control (RRC) signaling and ends in accordance with release of the periodic CSI-RS configuration.

15. The apparatus of claim 13, wherein:
the active CSI-RS starts from an end of a physical downlink control channel (PDCCH) including a request for the CSI report using the TRS and ends when a physical uplink shared channel (PUSCH) scheduled for transmission of the CSI report.

16. The apparatus of claim 13, wherein:
the active CSI-RS starts from receiving an activation command via a media access control (MAC) control element and ends when a deactivation command via another MAC control element is received.

17. An apparatus comprising memory coupled to a processor, the processor configured to:
transmit, to a user equipment (UE), a configuration to report time domain channel properties (TDCP) based on measurement of a tracking reference signal (TRS);
receive, from the UE, a number of channel state information (CSI) processing units (CPUs) required to report the TDCP based on the measurement of the TRS; and
receive, from the UE, a CSI report including the TDCP, the TDCP based on the measurement of the TRS.

18. A method, comprising:
receiving, at a user equipment (UE) from a network device, a configuration to report time domain channel properties (TDCP) based on measurement of a tracking reference signal (TRS);
measuring the TRS;
transmitting, from the UE to the network device, at least one of a processing time or a number of channel state information (CSI) processing units (CPUs) required to report the TDCP based on the measurement of the TRS; and
transmitting, from the UE, a CSI report including the TDCP, the TDCP based on the measurement of the TRS in accordance with an active channel state information reference signal (CSI-RS) rule.

19. The method of claim 18, wherein the CSI report is an aperiodic CSI report.

20. The method of claim 18, wherein a processing time for an aperiodic CSI report including the TDCP is a substantially similar processing time as a periodic CSI report not including the TDCP or a semi-persistent CSI report not including the TDCP.
